(19) United States
(12) Patent Application Publication
(10) Pub. No.: US 2003/0154096 A1
(43) Pub. Date: Aug. 14, 2003

(54) Manufacturer and client data processing system for use in exhibition site

(75) Inventors: Wei-Kang Lin, Taipei (TW); Chih-I Lin, Taipei (TW); Shih-Yu Tsou, Taipei (TW); Shengfu Lin, Taipei (TW)

Correspondence Address: BACON & THOMAS, PLLC, 625 SLATERS LANE, FOURTH FLOOR, ALEXANDRIA, VA, 22314

(73) Assignee: CMT Holding Inc., Taipei (TW)

(21) Appl. No.: 10/352,892

(22) Filed: Jan. 29, 2003

(30) Foreign Application Priority Data
Feb. 8, 2002 (TW) 91102554

(51) Int. Cl. G06F 17/60

(52) U.S. Cl. 705/1

(57) ABSTRACT

A system is designed to process manufacturer and client data in an exhibition site and is formed of one or more client servers, one or more manufacturer servers, and a site server. The client servers comprise a client data input-output device for a direct or indirect transmission of data via a client signal transmission device. The manufacturer servers comprise a manufacturer data input-output device for a direct or indirect transmission of data via a manufacturer signal transmission device. The site server comprises a site signal transmission device, one or more site input-output devices, a central processing unit, and a storage unit. The site signal transmission device is linked directly or indirectly with the client signal transmission device, the manufacturer transmission device, and the central processing unit, thereby enabling the central processing unit to transmit or receive the data.

### FIELD OF THE INVENTION

The present invention relates to a manufacturer and client data processing system for use in an exhibition site and a process flow of the system.

### BACKGROUND OF THE INVENTION

In preparation for a product exhibition, the product manufacturer is often liable to expend a substantial amount of funds on printing the brochures for promoting the products. After the product exhibition, the leftover brochures may become useless in the event that the products become eventually obsolete.

The promotional brochures are given away to those who happen to visit the manufacturer's kiosk which is set up in an exhibition site. As a result, the visitors are given as much promotional materials as they can manage upon having visited many kiosks. These promotional materials are often held by the visitors in a disorganizing manner. In addition, any one of the visitors may be a potential client, whose business background and data are important assets to the manufacturers. The exhibition kiosk is not equipped with an effective system to keep track of data of the visitors.

### SUMMARY OF THE INVENTION

It is the primary objective of the present invention to provide a system for processing manufacturer and client data in an exhibition site.

The system for processing manufacturer and client data in an exhibition site constructed according to the present invention comprises:

one or more client servers, each comprising a client data input-output device and a client signal transmission device whereby data of one or more visiting clients are fed into said client data input-output device such that the data are transmitted directly or indirectly by said client signal transmission device;

one or more manufacturer servers, each comprising a manufacturer data input-output device and a manufacturer signal transmission device whereby said manufacturer data input-output device is used to feed a client code of one or more visiting clients or a manufacturer code such that the client code and the manufacturers code are transmitted directly or indirectly by said manufacturer signal transmission device; and

a site server comprising one or more site signal transmission devices, one or more site input-output devices, a central processor, and a storage unit, with said site signal transmission device being linked directly or indirectly with said client signal transmission device, said manufacturer signal transmission device, and said central processor, thereby enabling said central processor to deliver or receive directly or indirectly the client data or code via said site signal transmission device, whereby said site input-output devices are used to receive one or more manufacturers data which are then transmitted directly or indirectly to said central processor for generation the manufacturer codes, with the manufacturer codes being delivered directly or indirectly to said manufacturer data input-output device via said site signal transmission device and said manufacturer signal transmission device, and with the client and the manufacturer data and codes being directly or indirectly transmitted by said central-processor to said storage unit in which the data and the codes of the client and the manufacturer are stored;

wherein said site signal transmission device receives directly or indirectly data of a visiting client from said client signal transmission device, thereby resulting in generation of a client code by said central processor such that the client code is delivered to said client signal transmission device, and that the client code is delivered to the visiting client by said client data input-output device, said central processor transmitting the data and the code of the visiting client to said storage unit in which the data and the code of the visiting client are stored;

wherein said site signal transmission device receives directly or indirectly the code of the visiting client and the manufacturer code from said manufacturer signal transmission device, thereby resulting in retrieval of the manufacturer data corresponding to the manufacturer code by said central processor from said storage unit such that the manufacturer data are transmitted to said client signal transmission device; and the manufacturer data are delivered to said visiting client by said client data input-output device at such time when the client code of said visiting client is fed into said client data input-output device.

It is another objective of the present invention to provide a process flow of a system for processing the manufacturer and client data in an exhibition site.

The process flow of a system for processing the manufacturer and client data in an exhibition site of the present invention comprises the steps of:

(1) inputting data of one or more manufacturers into one or more site input-output devices of a site server;

(2) transmitting the data by said site input-output devices to a central processor of said site server, whereby said central processor generates one or more manufacturer codes;

(3) transmitting the data and the manufacture codes by said central processor to a storage unit of said site server such that the data and the manufacture codes are stored in said storage unit, which are transmitted to said site input-output devices;

(4) outputting the manufacturer codes by said site input-output devices to, the manufacturers;

(5) inputting data of one or more clients into one or more client data input-output devices of a client server;

(6) transmitting the client data directly or indirectly by a client signal transmission device of said client server;

(7) receiving directly or indirectly the client data by a site signal transmission device of a site server such that the client data are transmitted to said central processor, whereby said central processor generates one or more client codes;

(8) transmitting the client data and said client codes by said central processor to said storage unit in which the client data and said client codes are stored, which are transmitted to said site signal transmission device;

(9)transmitting directly or indirectly the client codes by said site signal transmission device;

(10) receiving directly or indirectly the client codes by said client signal transmission device such that the client codes are transmitted to said client data input-output devices;

(11) delivering the client codes to the clients by said client data input-output devices;

(12) admitting the clients to the exhibition site on the basis of the client codes;

(13) inputting the client code of one visiting client and the manufacturer code of a manufacturer into a manufacturer data input-output device of a manufacturer server;

(14) transmitting directly or indirectly the client code and the manufacturer code by a manufacturer signal transmission device of said manufacturer server;

(15) receiving directly or indirectly the manufacturer code and the client code by said site signal transmission device such that the manufacturer code and the client code are transmitted to said central processor;

(16) receiving the manufacturer code and the client code by said central processor such that the manufacturer data are retrieved from said storage unit according to the manufacturer code, and that a data register area is established in accordance with the client code, and further that the manufacturer data are temporarily held in said data register area;

(17) repeating the steps (13) to (16) by another manufacturer, thereby the data of another manufacturer is held temporarily in said data register area;

(18) inputting the client code into said client data input-output device;

(19) transmitting directly or indirectly the client code by said client signal transmission device;

(20) receiving directly or indirectly the client code by said site signal transmission device such that the client code is transmitted to said central processor;

(21) receiving and identifying the client code by said central processor so as to transmit all of the manufacturer data in said data register area corresponding to said client code to said site signal transmission device from said data register area;

(22) transmitting directly or indirectly the manufacturer data by said site signal transmission device;

(23) receiving directly or indirectly the manufacturer data by said client signal transmission device such that the manufacturer data are transmitted to said client data input-output device;

(24) outputting the manufacturer data according to the client code by said client data input-output device to the client;

(25) inputting the manufacturer code into said manufacturer data input-output device by the manufacturers;

(26) transmitting directly or indirectly the manufacturer code by said manufacturer signal transmission device such that the manufacturer code is received directly or indirectly by said site signal transmission device;

(27) transmitting the manufacturer code to said central processor by said site signal transmission device;

(28) transmitting the manufacturer data and the client data from said storage unit to said site signal transmission device by said central processor in accordance with the manufacturer code;

(29) transmitting directly or indirectly the manufacturer data and the client data by said site signal transmission device such that the manufacturer data and the client data are received directly or indirectly by said manufacturer signal transmission device; and

(30) transmitting the manufacturer data and the client data by said manufacturer signal transmission device to said manufacturer data input-output device by which the data are delivered to the manufacturer.

It is another objective of the present invention to provide a system for providing manufacturer data in an exhibition site, said system comprising:

one or more manufacturer servers, each comprising a manufacturer data input-output device and a manufacturer signal transmission device whereby said manufacturer data input-output device is linked directly or indirectly with said manufacturer signal transmission device; and

a site server comprising a site signal transmission device, one or more site input-output devices, a central processing unit, and a storage unit whereby said site signal transmission device is linked directly or indirectly with said manufacturer signal transmission device and said central processing unit;

wherein said site input-output devices are used to input one or more manufacturer data of manufacturers such that the data are transmitted directly or indirectly to said central processing unit by which one or more manufacturer codes are created, with the codes being transmitted to said site input-output devices by which the codes are delivered to the manufacturers, or with the codes being transmitted directly or indirectly by said site signal transmission device and said manufacturer signal transmission device to said manufacturer data input-output devices by which the codes are delivered to the manufacturers, with the manufacturer data and codes being transmitted directly or indirectly by said central processing unit to said storage unit in which the manufacturer data and codes are stored.

It is still another objective of the present invention to provide a process flow of a system for providing manufacturer data in an exhibition site, said process flow comprising the steps of:

(1) inputting data of one or more manufacturers into one or more site input-output devices of a site server;

(2) transmitting the data of the manufacturers to a central processing unit of said site server by said site input-output devices;

(3) transmitting the manufacturers data by said central processing unit to a storage unit of said site server in which the data are stored whereby said central processing unit creates one or more manufacturer codes which are transmitted to said site input-output devices and one or more site signal transmission devices of said site server;

(4) outputting the manufacturer codes to the manufacturers by said site input-output devices;

(5) transmitting the manufacturer codes directly or indirectly by said site signal transmission device to a manufacturer signal transmission device of a manufacturer server; and

(6) transmitting the manufacturer codes by said manufacturer signal transmission device to a manufacturer data input-output device of said manufacturer server whereby the manufacturer codes are delivered to the manufacturers by said manufacturer data input-output device.

It is still another objective of the present invention to provide a system for providing client data in an exhibition site, said system comprising:

one or more client servers, each comprising a client data input-output device and a client signal transmission device whereby data of one or more visiting clients are fed into said client data input-output device such that the data are transmitted directly or indirectly by said client signal transmission device; and

a site server comprising one or more site signal transmission devices, one or more site input-output devices, a central processor, and a storage unit, with said site signal transmission device being linked directly or indirectly with said client signal transmission device, and said central processor;

wherein said site signal transmission device receives directly or indirectly data of a visiting client from said client signal transmission device, thereby resulting in generation of a client code by said central processor such that the client code is delivered to said client signal transmission device, and that the client code is delivered to the visiting client by said client data input-output device, said central processor transmitting the data and the code of the visiting client to said storage unit in which the data and the code of the visiting client are stored.

It is still another objective of the present invention to provide a process flow of a system for providing client data in an exhibition site, said process flow comprising the steps of:

(1) inputting data of one or more clients into one or more client data input-output devices of a client server;

(2) transmitting the client data directly or indirectly by a client signal transmission device of said client server;

(3) receiving directly or indirectly the client data by a site signal transmission device of a site server such that the client data are transmitted to a central processor of said site server, whereby said central processor generates one or more client codes;

(4) transmitting the client data and said client codes by said central processor to a storage unit in which the client data and said client codes are stored, which are transmitted to said site signal transmission device;

(5) transmitting directly or indirectly the client codes by said site signal transmission device;

(6) receiving directly or indirectly the client codes by said client signal transmission device such that the client codes are transmitted to said client data input-output devices;

(7) delivering the client codes to the clients by said client data input-output devices; and

(8) admitting the clients to the exhibition site on the basis of the client codes.

It is still another objective of the present invention to provide client inclination data output system for use in an exhibition site, said system comprising:

a portable data storage device;

one or more client servers, each comprising a client data input-output device and a client signal transmission device whereby data of one or more visiting clients are fed into said client data input-output device such that the data are transmitted directly or indirectly by said client signal transmission device;

one or more manufacturer servers, each comprising a manufacturer data input-output device and a manufacturer signal transmission device whereby said manufacturer data input-output device is used to feed a client code of one or more visiting clients or a manufacturer code such that the client code and the manufacturers code are transmitted directly or indirectly by said manufacturer signal transmission device; and

a site server comprising one or more site signal transmission devices, one or more site input-output devices, a central processor, and a storage unit, with said site signal transmission device being linked directly or indirectly with said client signal transmission device, said manufacturer signal transmission device, and said central processor;

wherein said site signal transmission device receives directly or indirectly the code of the visiting client and the manufacturer code from said manufacturer signal transmission device, thereby resulting in retrieval of the manufacturer data corresponding to the manufacturer code by said central processor from said storage unit such that the manufacturer data are transmitted to said client signal transmission device; and the manufacturer data are delivered to said visiting client by said portable data storage device at such time when the client code of said visiting client is fed into said client data input-output device.

It is still another objective of the present invention to provide process flow of a client inclination data output system for use in an exhibition site, said process flow comprising the steps of:

(1) inputting a client code of one visiting client and a manufacturer code of a manufacturer into a manufacturer data input-output device of a manufacturer server;

(2) transmitting directly or indirectly the client code and the manufacturer code by a manufacturer signal transmission device of said manufacturer server;

(3) receiving directly or indirectly the manufacturer code and the client code by a site signal transmission device of a site server such that the manufacturer code and the client code are transmitted to a central processor of said site server;

(4) receiving the manufacturer code and the client code by said central processor such that the manufacturer data are retrieved from a storage unit according to the manufacturer code, and that a data register area is established in accordance with the client code, and further that the manufacturer data are temporarily held in said data register area;

(5) repeating the steps (1) to (4) by another manufacturer, thereby the data of another manufacturer is held temporarily in said data register area;

(6) inputting the client code into a client data input-output device of a client server;

(7) transmitting directly or indirectly the client code by a client signal transmission device of said client server;

(8) receiving directly or indirectly the client code by said site signal transmission device such that the client code is transmitted to said central processor;

(9) receiving and identifying the client code by said central processor so as to transmit all of the manufacturer data in said data register area corresponding to said client code to said site signal transmission device from said data register area;

(10) transmitting directly or indirectly the manufacturer data by said site signal transmission device;

(11) receiving directly or indirectly the manufacturer data by said client signal transmission device such that the manufacturer data are transmitted to said client data input-output device; and

(12) outputting the manufacturer data according to the client code by said client data input-output device to the client.

It is still another objective of the present invention to provide a process flow of a system for manufacturer reviewing and analyzing potential clients in an exhibition site, said process flow comprising the following steps of:

(1) inputting a manufacturer code of a manufacturer into a manufacturer data input-output device;

(2) transmitting directly or indirectly the manufacturer code by a manufacturer signal transmission device such that the manufacturer code is received directly or indirectly by a site signal transmission device of a site server;

(3) transmitting the manufacturer code to a central processor of said site server by said site signal transmission device;

(4) transmitting the manufacturer data and the client data from a storage unit to said site signal transmission device by said central processor in accordance with the manufacturer code;

(5) transmitting directly or indirectly the manufacturer data and the client data by said site signal transmission device such that the manufacturer data and the client data are received directly or indirectly by said manufacturer signal transmission device; and

(6) transmitting the manufacturer data and the client data by said manufacturer signal transmission device to said manufacturer data input-output device by which the data are delivered to the manufacturer.

Preferably, said client data input-output device of said client server, said manufacturer data input-output device of said manufacturer server, and said site input-output device of said site server comprise a bar code scanner, an optical scanner, a retrieving device of a magnetic recorder, a retrieving device of an optical recorder, or a keyboard device; and a display, an optical recorder, a magnetic recorder, or a printer.

Preferably, said client signal transmission device of said client server, said manufacturer signal transmission device of said manufacturer server, and said site signal transmission device of said site server comprise a radio transceiver, or a RFID wireless modem.

The present invention is further explained by a preferred embodiment with reference to the accompanying drawings.

### BRIEF DESCRIPTION OF THE DRAWINGS

FIG. 1 shows servers, devices or data source block diagrams of the manufacturer, client data processing system of the present invention.

FIG. 2 is the process flow of the system as shown in FIG. 1.

FIG. 3 shows servers, devices or data source block diagrams of another manufacturer and client data providing system of the present invention.

FIG. 4 show the process flow of the system as shown in FIG. 3.

FIG. 5 shows servers, devices or data source block diagrams of another manufacturer and client data providing system of the present invention.

FIG. 6 shows the process flow of the system as shown in FIG. 5.

FIG. 7 shows the servers, devices or data source block diagrams of the client inclination data output device of the present invention.

FIG. 8 shows the process flow of the device as shown in FIG. 7.

FIG. 9 shows the process flow of the manufacturer review and the potential client analyzing system of the present invention.

### DETAILED DESCRIPTION OF THE PREFERRED EMBODIMENTS

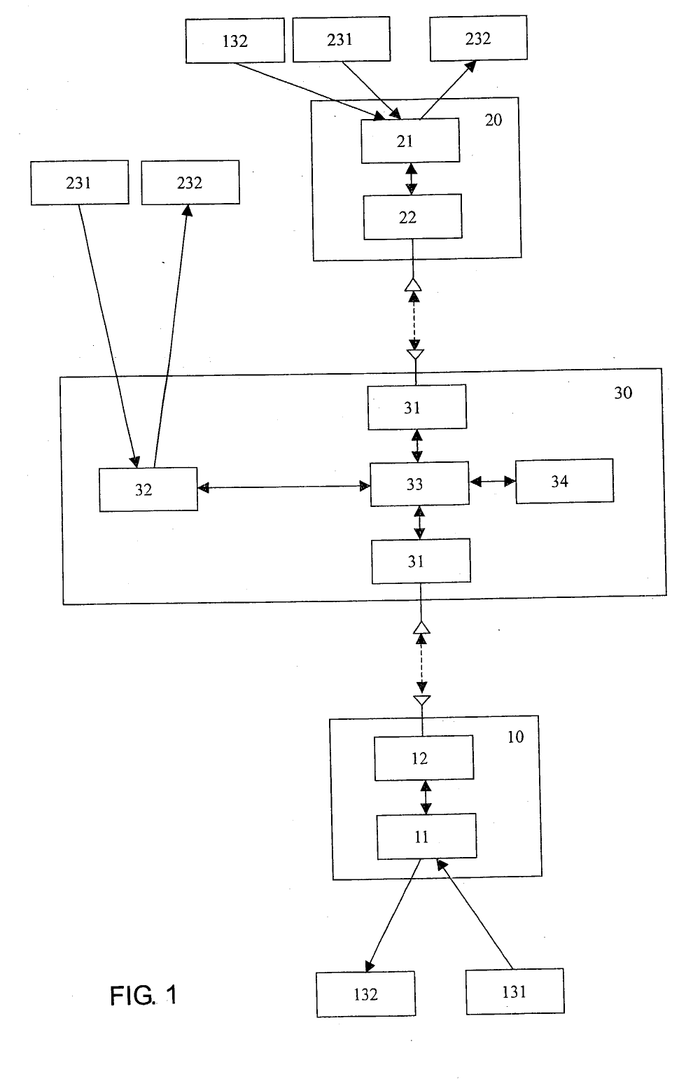

FIG. 1 shows the manufacturer and client data processing system for use in an exhibition site. The system comprises a client server 10, a client data input-output device 11, a client signal transmission device 12, a client data input source 131, such as one or more visiting client data, a client data output source 132, such as one or more client codes, or one or more portable data storage devices given to the clients, a manufacturer server 20, a manufacturer data input-output device 21, a manufacturer signal transmission device 22, a manufacturer data input source 231, such as one or more participating manufacturers data, a manufacturer data output source 232, such as one or more participating manufactures codes or other exhibition-related data, an exhibition site server 30, one or more site signal transmission devices 31, a site input-output device 32, a central processor 33, and a storage unit 34.

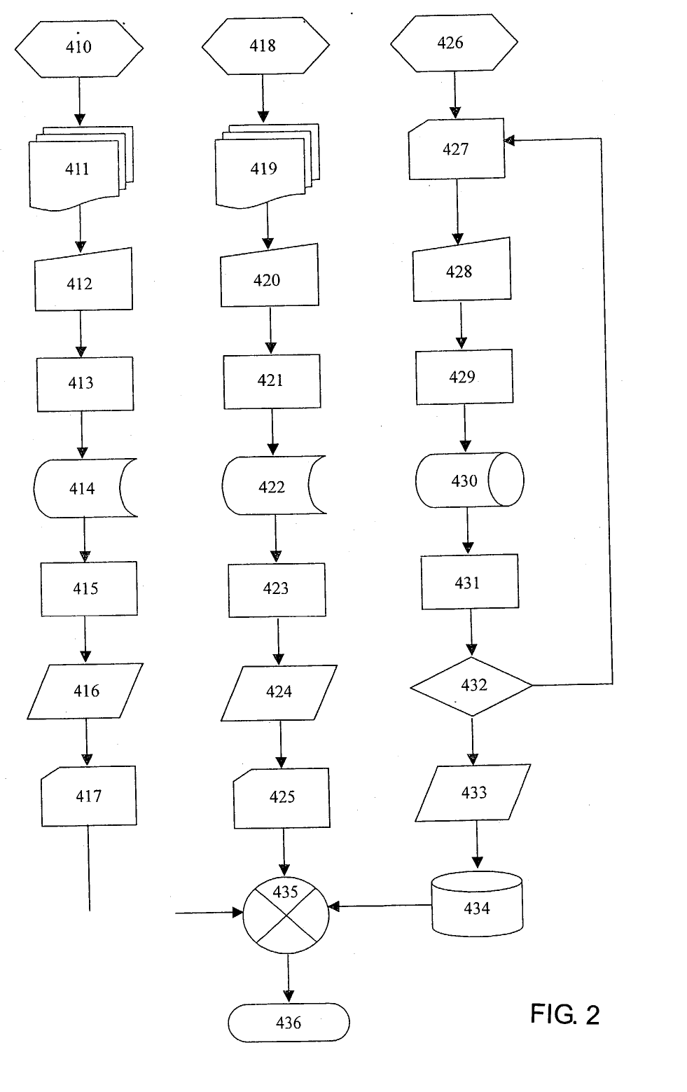

FIG. 2 shows the process flow of the manufacturer and client data processing system for use in an exhibition site. The process flow is described as follows: 410 is system preparation. 411 is manufacturer data preparation. 412 is input of site input-output device. 413 is the process of the central processor. 414 is storage of the storage unit. 415 is generation of the manufacturer code and delivery of the central processor. 416 is the site input-output device or the output of manufacturer data input-output device. 417 is the manufacturer code. 418 is system preparation. 419 is client data preparation. 420 is input of the client data input-output device. 421 is the processing of the central processor. 422 is storage of the storage unit. 423 is generation of the client code and the delivery of the central processor. 424 is output of the client data input-output device. 425 is the client code. 426 is the system preparation. 427 is the preparation of the manufacturer and the client codes. 428 is input of the manufacturer data input-output device. 429 is the process of the central processor. 430 is retrieval of the manufacturer data from the storage unit. 431 is generation of the client code register area by the central processor and the register. 432 is identification of the end by the central processor. 433 is output of the client data input-output device. 434 is the portable data storage device. 435 is the convergent process point. 436 is conclusion of system.

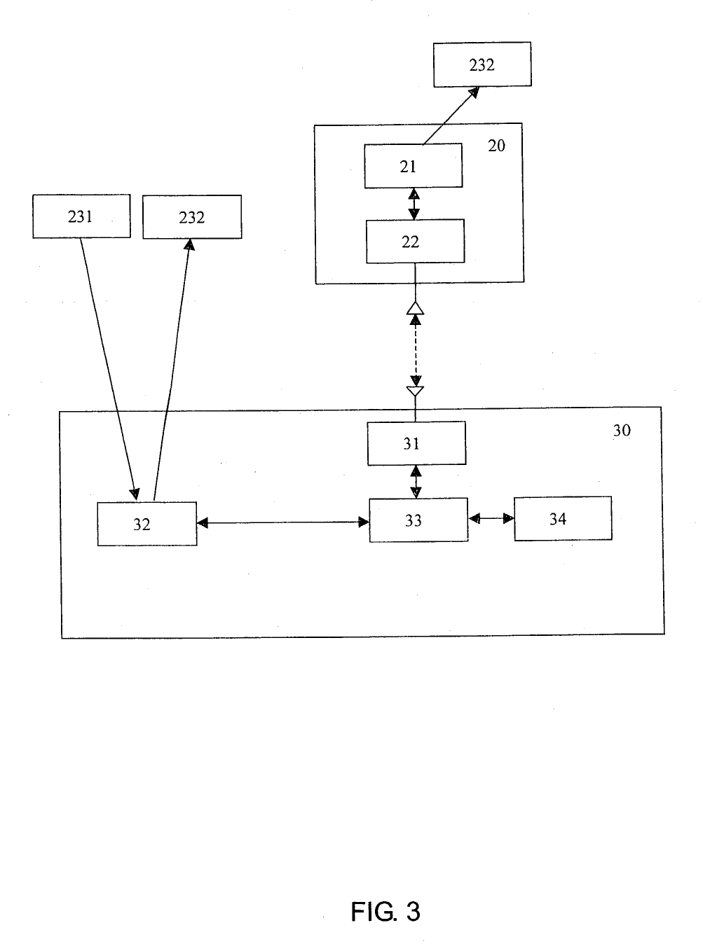

FIG. 3 shows the device for providing the manufacturer data in an exhibition site. The definitions of the block diagrams and the reference numerals are the same as those of FIG. 1.

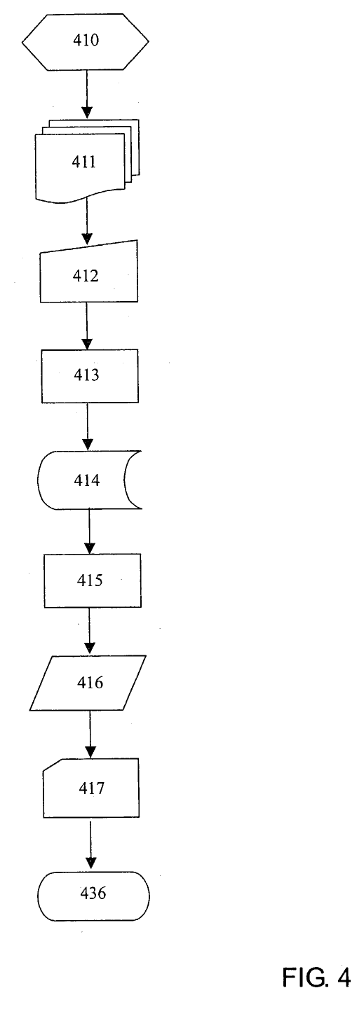

FIG. 4 shows the device for providing the manufacturer data in an exhibition site. The definitions of reference numerals are the same as those of FIG. 2.

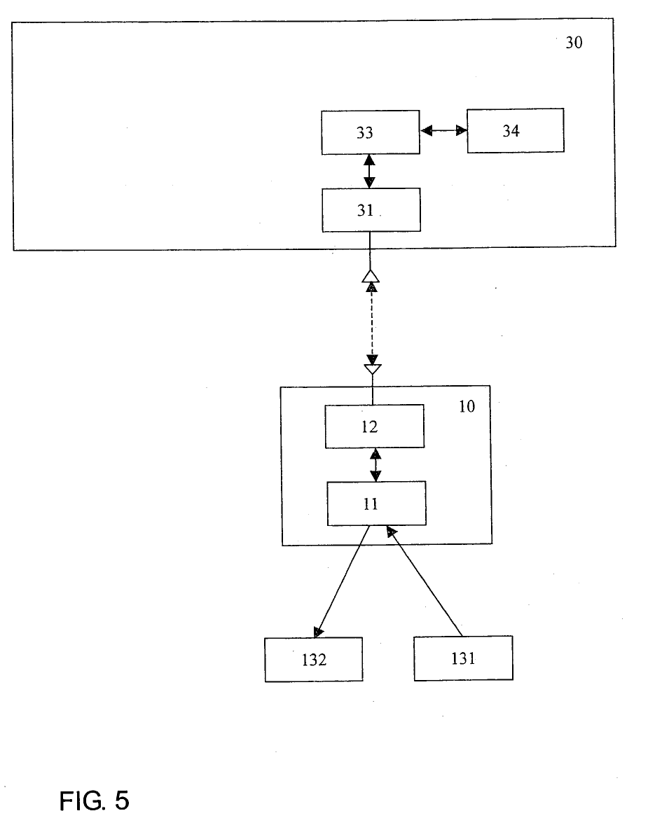

FIG. 5 shows the device for providing the client data in an exhibition site. The definitions of the block diagrams and the reference numerals are the same as those of FIG. 1.

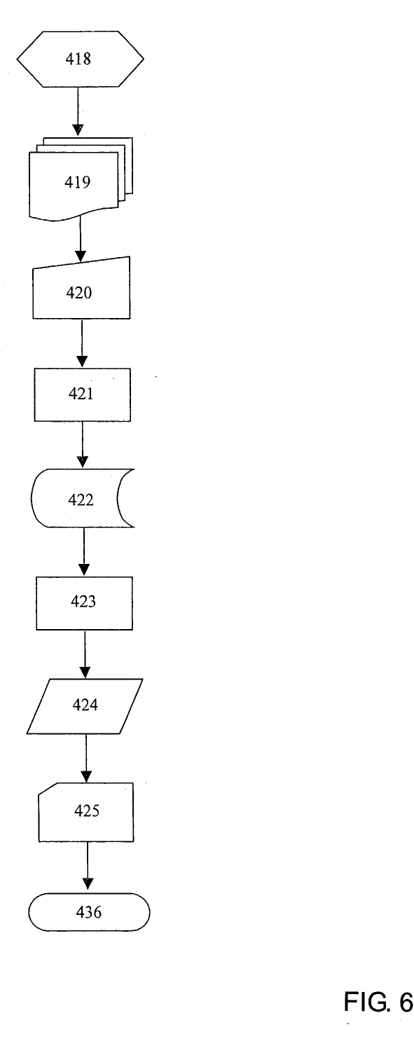

FIG. 6 shows the device for providing the client data in an exhibition site. The definition of the process flow and the reference numerals are the same as those of FIG. 2.

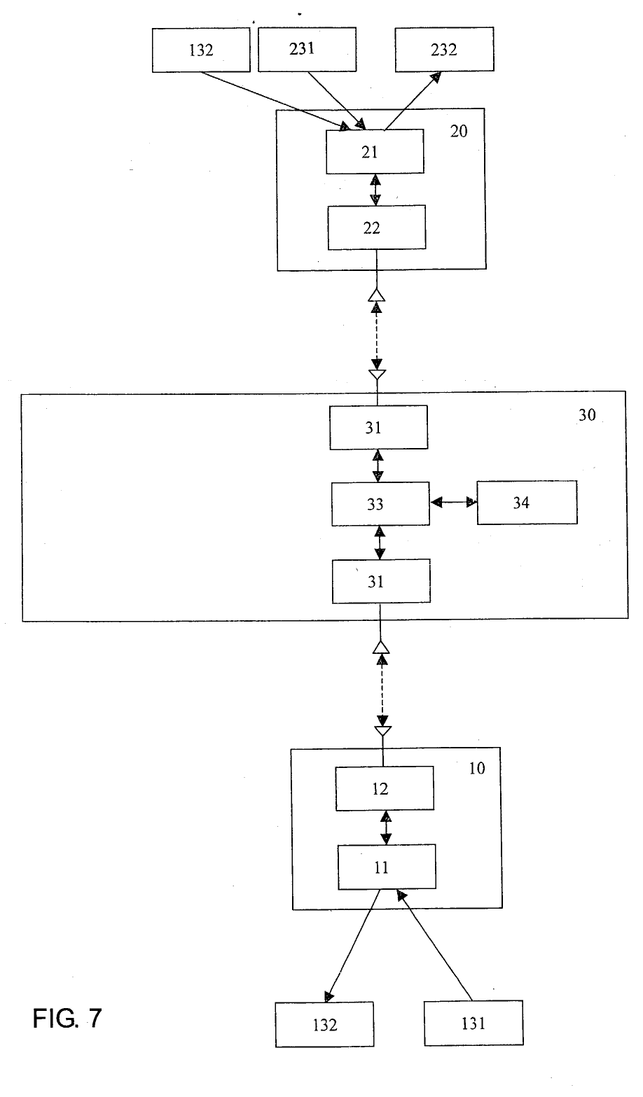

FIG. 7 shows the client inclination data output device for use in an exhibition site. The definitions of the block diagrams and the reference numerals are the same as those of FIG. 1.

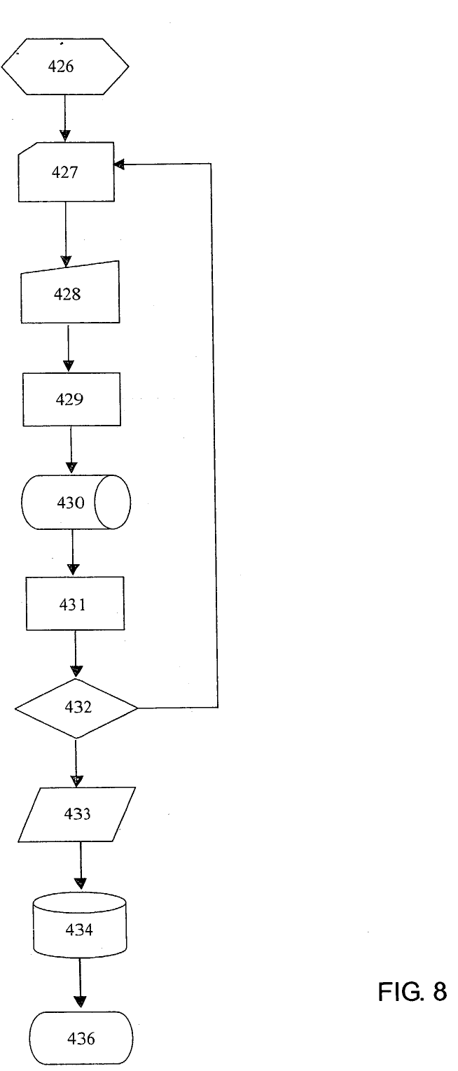

FIG. 8 shows the client inclination data output device for use in an exhibition site. The definitions of the process flow and the reference numerals are the same as those of FIG. 2.

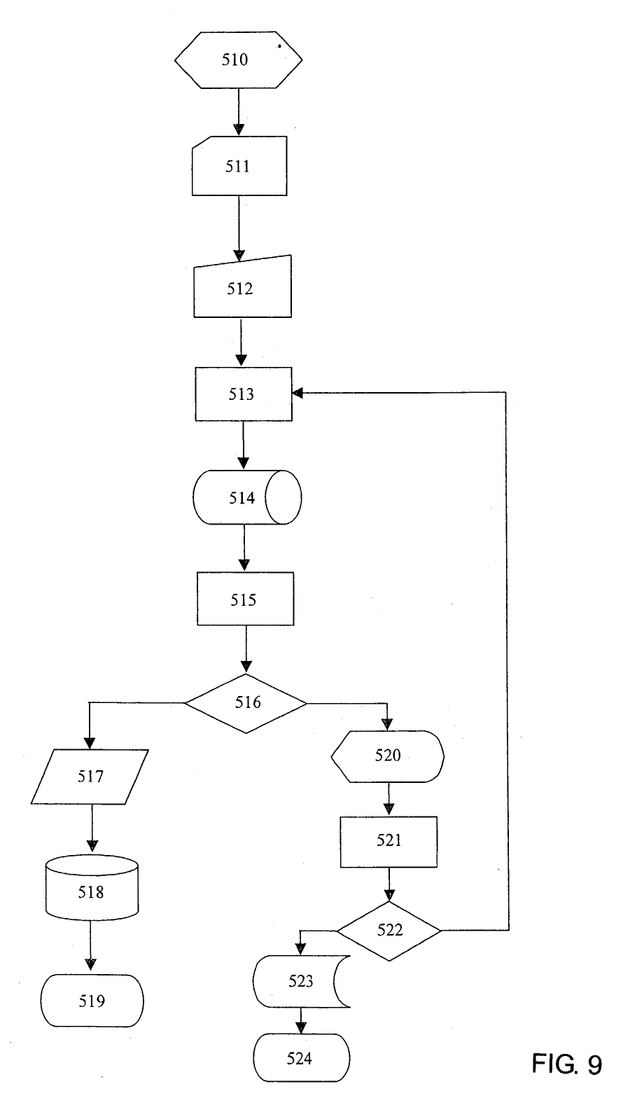

FIG. 9 shows the manufacturer review and the potential client analyzing system for use in an exhibition site. The process flow is explained as follows. 510 is system preparation. 511 is the manufacturer code preparation. 512 is input of the manufacturer data input-output device. 513 is the processing of the central processing unit. 514 is retrieval of the manufacturer or client data from the storage unit. 515 is the processing of the central processing unit. and the delivery. 516 is identification of conclusion by the central processing unit. 517 is output of the manufacturer data input-output device. 518 is output of portable data storage device. 519 is end of the-system. 520 is the display of the manufacturer data input-output device. 521 is amendment or deletion of data. 522 is identification of conclusion by the central processing unit. 523 is storage process of the storage unit. 524 is end of the system.

What is claimed is:

1. A system for processing manufacturer and client data in an exhibition site, said system comprising:
one or more client servers, each comprising a client data input-output device and a client signal transmission device whereby data of one or more visiting clients are fed into said client data input-output device such that the data are transmitted directly or indirectly by said client signal transmission device;
one or more manufacturer servers, each comprising a manufacturer data input-output device and a manufacturer signal transmission device whereby said manufacturer data input-output device is used to feed a client code of one or more visiting clients or a manufacturer code such that the client code and the manufacturers code are transmitted directly or indirectly by said manufacturer signal transmission device; and
a site server comprising one or more site signal transmission devices, one or more site input-output devices, a central processor, and a storage unit, with said site signal transmission device being linked directly or indirectly with said client signal transmission device, said manufacturer signal transmission device, and said central processor, thereby enabling said central processor to deliver or receive directly or indirectly the client data or code via said site signal transmission device, whereby said site input-output devices are used to receive one or more manufacturers data which are then transmitted directly or indirectly to said central processor for generation the manufacturer codes, with the manufacturer codes being delivered directly or indirectly to said manufacturer data input-output device via said site signal transmission device and said manufacturer signal transmission device, and with the client and the manufacturer data and codes being directly or indirectly transmitted by said central processor to said storage unit in which the data and the codes of the client and the manufacturer are stored;
wherein said site signal transmission device receives directly or indirectly data of a visiting client from said client signal transmission device, thereby resulting in generation of a client code by said central processor such that the client code is delivered to said client signal transmission device, and that the client code is delivered to the visiting client by said client data input-output device, said central processor transmitting the data and the code of the visiting client to said storage unit in which the data and the code of the visiting client are stored;
wherein said site signal transmission device receives directly or indirectly the code of the visiting client and the manufacturer code from said manufacturer signal transmission device, thereby resulting in retrieval of the manufacturer data corresponding to the manufacturer code by said central processor from said storage unit such that the manufacturer data are transmitted to said client signal transmission device; and the manufacturer data are delivered to said visiting client by said client data input-output device at such time when the client code of said visiting client is fed into said client data input-output device.

2. A process flow of a system for processing the manufacturer and client data in an exhibition site, said process flow comprising the steps of:
(2) inputting data of one or more manufacturers into one or more site input-output devices of a site server;
(2) transmitting the data by said site input-output devices to a central processor of said site server, whereby said central processor generates one or more manufacturer codes;
(3) transmitting the data and the manufacture codes by said central processor to a storage unit of said site server such that the data and the manufacture codes are stored in said storage unit, which are transmitted to said site input-output devices;
(4) outputting the manufacturer codes by said site input-output devices to the manufacturers;
(5) inputting data of one or more clients into one or more client data input-output devices of a client server;
(6) transmitting the client data directly or indirectly by a client signal transmission device of said client server;
(7) receiving directly or indirectly the client data by a site signal transmission device of a site server such that the client data are transmitted to said central processor, whereby said central processor generates one or more client codes;
(8) transmitting the client data and said client codes by said central processor to said storage unit in which the client data and said client codes are stored, which are transmitted to said site signal transmission device;
(10) transmitting directly or indirectly the client codes by said site signal transmission device;
(10) receiving directly or indirectly the client codes by said client signal transmission device such that the client codes are transmitted to said client data input-output devices;
(11) delivering the client codes to the clients by said client data input-output devices;
(12) admitting the clients to the exhibition site on the basis of the client codes; :
(13) inputting the client code of one visiting client and the manufacturer code of a manufacturer into a manufacturer data input-output device of a manufacturer server;
(14) transmitting directly or indirectly the client code and the manufacturer code by a manufacturer signal transmission device of said manufacturer server;
(15) receiving directly or indirectly the manufacturer code and the client code by said site signal transmission device such that the manufacturer code and the client code are transmitted to said central processor;
(16) receiving the manufacturer code and the client code by said central processor such that the manufacturer data are retrieved from said storage unit according to the manufacturer code, and that a data register area is established in accordance with the client code, and further that the manufacturer data are temporarily held in said data register area;
(17) repeating the steps (13) to (16) by another manufacturer, thereby the data of another manufacturer is held temporarily in said data register area;
(18) inputting the client code into said client data input-output device;
(19) transmitting directly or indirectly the client code by said client signal transmission device;
(20) receiving directly or indirectly the client code by said site signal transmission device such that the client code is transmitted to said central processor;
(21) receiving and identifying the client code by said central processor so as to transmit all of the manufacturer data in said data register area corresponding to said client code to said site signal transmission device from said data register area;
(22) transmitting directly or indirectly the manufacturer data by said site signal transmission device;
(23) receiving directly or indirectly the manufacturer data by said client signal transmission device such that the manufacturer data are transmitted to said client data input-output device;
(24) outputting the manufacturer data according to the client code by said client data input-output device to the client;
(25) inputting the manufacturer code into said manufacturer data input-output device by the manufacturers;
(26) transmitting directly or indirectly the manufacturer code by said manufacturer signal transmission device such that the manufacturer code is received directly or indirectly by said site signal transmission device;
(27) transmitting the manufacturer code to said central processor by said site signal transmission device;
(28) transmitting the manufacturer data and the client data from said storage unit to said site signal transmission device by said central processor in accordance with the manufacturer code;
(29) transmitting directly or indirectly the manufacturer data and the client data by said site signal transmission device such that the manufacturer data and the client data are received directly or indirectly by said manufacturer signal transmission device; and
(30) transmitting the manufacturer data and the client data by said manufacturer signal transmission device to said manufacturer data input-output device by which the data are delivered to the manufacturer.

3. A system for providing manufacturer data in an exhibition site, said system comprising:
one or more manufacturer servers, each comprising a manufacturer data input-output device and a manufacturer signal transmission device whereby said manufacturer data input-output device is linked directly or indirectly with said manufacturer signal transmission device; and
a site server comprising a site signal transmission device, one or more site input-output devices, a central processing unit, and a storage unit whereby said site signal transmission device is linked directly or indirectly with said manufacturer signal transmission device and said central processing unit;
wherein said site input-output devices are used to input one or more manufacturer data of manufacturers such that the data are transmitted directly or indirectly to said central processing unit by which one or more manufacturer codes are created, with the codes being transmitted to said site input-output devices by which the codes are delivered to the manufacturers, or with the codes being transmitted directly or indirectly by said site signal transmission device and said manufacturer signal transmission device to said manufacturer data input-output devices by which the codes are delivered to the manufacturers, with the manufacturer data and codes being transmitted directly or indirectly by said central processing unit to said storage unit in which the manufacturer data and codes are stored.

4. A process flow of a system for providing manufacturer data in an exhibition site, said process flow comprising the steps of:
(1) inputting data of one or more manufacturers into one or more site input-output devices of a site server;
(2) transmitting the data of the manufacturers to a central processing unit of said site server by said site input-output devices;
(3) transmitting the manufacturers data by said central processing unit to a storage unit of said site server in which the data are stored whereby said central processing unit creates one or more manufacturer codes which are transmitted to said site input-output devices and one or more site signal transmission devices of said site server;
(4) outputting the manufacturer codes to the manufacturers by said site input-output devices;
(5) transmitting the manufacturer codes directly or indirectly by said site signal transmission device to a manufacturer signal transmission device of a manufacturer server; and
(6) transmitting the manufacturer codes by said manufacturer signal transmission device to a manufacturer data input-output device of said manufacturer server whereby the manufacturer codes are delivered to the manufacturers by said manufacturer data input-output device.

5. A system for providing client data in an exhibition site, said system comprising:
one or more client servers, each comprising a client data input-output device and a client signal transmission device whereby data of one or more visiting clients are fed into said client data input-output device such that the data are transmitted directly or indirectly by said client signal transmission device; and
a site server comprising one or more site signal transmission devices, one or more site input-output devices, a central processor, and a storage unit, with said site signal transmission device being linked directly or indirectly with said client signal transmission device, and said central processor;
wherein said site signal transmission device receives directly or indirectly data of a visiting client from said client signal transmission device, thereby resulting in generation of a client code by said central processor such that the client code is delivered to said client signal transmission device, and that the client code is delivered to the visiting client by said client data input-output device, said central processor transmitting the data and the code of the visiting client to said storage unit in which the data and the code of the visiting client are stored.

6. A process flow of a system for providing client data in an exhibition site, said process flow comprising the steps of:
(1) inputting data of one or more clients into one or more client data input-output devices of a client server;
(2) transmitting the client data directly or indirectly by a client signal transmission device of said client server;
(3) receiving directly or indirectly the client data by a site signal transmission device of a site server such that the client data are transmitted to a central processor of said site server, whereby said central processor generates one or more client codes;
(4) transmitting the client data and said client codes by said central processor to a storage unit in which the client data and said client codes are stored, which are transmitted to said site signal transmission device;
(5) transmitting directly or indirectly the client codes by said site signal transmission device;
(6) receiving directly or indirectly the client codes by said client signal transmission device such that the client codes are transmitted to said client data input-output devices;
(7) delivering the client codes to the clients by said client data input-output devices; and
(8) admitting the clients to the exhibition site on the basis of the client codes.

7. A client inclination data output system for use in an exhibition site, said system comprising:
a portable data storage device;
one or more client servers, each comprising a client data input-output device and a client signal transmission device whereby data of one or more visiting clients are fed into said client data input-output device such that the data are transmitted directly or indirectly by said client signal transmission device;
one or more manufacturer servers, each comprising a manufacturer data input-output device and a manufacturer signal transmission device whereby said manufacturer data input-output device is used to feed a client code of one or more visiting clients or a manufacturer code such that the client code and the manufacturers code are transmitted directly or indirectly by said manufacturer signal transmission device; and
a site server comprising one or more site signal transmission devices, one or more site input-output devices, a central processor, and a storage unit, with said site signal transmission device being linked directly or indirectly with said client signal transmission device, said manufacturer signal transmission device, and said central processor;
wherein said site signal transmission device receives directly or indirectly the code of the visiting client and the manufacturer code from said manufacturer signal transmission device, thereby resulting in retrieval of the manufacturer data corresponding to the manufacturer code by said central processor from said storage unit such that the manufacturer data are transmitted to said client signal transmission device; and the manufacturer data are delivered to said visiting client by said portable data storage device at such time when the client code of said visiting client is fed into said client data input-output device.

8. A process flow of a client inclination data output system for use in an exhibition site, said process flow comprising the steps of:
(1) inputting a client code of one visiting client and a manufacturer code of a manufacturer into a manufacturer data input-output device of a manufacturer server;
(2) transmitting directly or indirectly the client code and the manufacturer code by a manufacturer signal transmission device of said manufacturer server;
(3) receiving directly or indirectly the manufacturer code and the client code by a site signal transmission device of a site server such that the manufacturer code and the client code are transmitted to a central processor of said site server;
(4) receiving the manufacturer code and the client code by said central processor such that the manufacturer data are retrieved from a storage unit according to the manufacturer code, and that a data register area is established in accordance with the client code, and further that the manufacturer data are temporarily held in said data register area;
(5) repeating the steps (1) to (4) by another manufacturer, thereby the data of another manufacturer is held temporarily in said data register area;
(6) inputting the client code into a client data input-output device of a client server;
(7) transmitting directly or indirectly the client code by a client signal transmission device of said client server;
(8) receiving directly or indirectly the client code by said site signal transmission device such that the client code is transmitted to said central processor;
(9) receiving and identifying the client code by said central processor so as to transmit all of the manufacturer data in said data register area corresponding to said client code to said site signal transmission device from said data register area;
(10) transmitting directly or indirectly the manufacturer data by said site signal transmission device;
(11) receiving directly or indirectly the manufacturer data by said client signal transmission device such that the manufacturer data are transmitted to said client data input-output device; and
(12) outputting the manufacturer data according to the client code by said client data input-output device to the client.

9. A process flow of a system for manufacturer reviewing and analyzing potential clients in an exhibition site, said process flow comprising the following steps of:
(1) inputting a manufacturer code of a manufacturer into a manufacturer data input-output device;
(2) transmitting directly or indirectly the manufacturer code by a manufacturer signal transmission device such that the manufacturer code is received directly or indirectly by a site signal transmission device of a site server;
(3) transmitting the manufacturer code to a central processor of said site server by said site signal transmission device;
(4) transmitting the manufacturer data and the client data from a storage unit to said site signal transmission device by said central processor in accordance with the manufacturer code;
(5) transmitting directly or indirectly the manufacturer data and the client data by said site signal transmission device such that the manufacturer data and the client data are received directly or indirectly by said manufacturer signal transmission device; and
(6) transmitting the manufacturer data and the client data by said manufacturer signal transmission device to said manufacturer data input-output device by which the data are delivered to the manufacturer.

10. The system as defined in claim 1, wherein said client data input-output device of said client server, said manufacturer data input-output device of said manufacturer server, and said site input-output device of said site server comprise a bar code scanner, an optical scanner, a retrieving device of a magnetic recorder, a retrieving device of an optical recorder, or a keyboard device; and a display, an optical recorder, a magnetic recorder, or a printer.

11. The system as defined in claim 1, wherein said client signal transmission device of said client server, said manufacturer signal transmission device of said manufacturer server, and said site signal transmission device of said site server comprise a radio transceiver, or a RFID wireless modem.

12. The system as defined in claim 3, wherein said manufacturer data input-output device of said manufacturer server, and said site input-output device of said site server comprise a bar code scanner, an optical scanner, a retrieving device of a magnetic recorder, a retrieving device of an optical recorder, or a keyboard device; and a display, an optical recorder, a magnetic recorder, or a printer.

13. The system as defined in claim 3, wherein said manufacturer signal transmission device of said manufacturer server, and said site signal transmission device of said site server comprise a radio transceiver, or a RFID wireless modem.

14. The system as defined in claim 5, wherein said client data input-output device of said client server, and said site input-output device of said site server comprise a bar code scanner, an optical scanner, a retrieving device of a magnetic recorder, a retrieving device of an optical recorder, or a keyboard device; and a display, an optical recorder, a magnetic recorder, or a printer.

15. The system as defined in claim 5, wherein said client signal transmission device of said client server, and said site signal transmission device of said site server comprise a radio transceiver, or a RFID wireless modem.

16. The system as defined in claim 7, wherein said client data input-output device of said client server, and said manufacturer data input-output device of said manufacturer server comprise a bar code scanner, an optical scanner, a retrieving device of a magnetic recorder, a retrieving device of an optical recorder, or a keyboard device; and a display, an optical recorder, a magnetic recorder, or a printer.

17. The system as defined in claim 7, wherein said client signal transmission device of said client server, said manufacturer signal transmission device of said manufacturer server, and said site signal transmission device of said site server comprise a radio transceiver, or a RFID wireless modem.

18. The system as defined in claim 7, wherein said portable data storage device is an optical recorder, and/or a magnetic recorder, and/or an integrated circuit recorder.
